(19) United States
(12) Patent Application Publication
(10) Pub. No.: US 2005/0240515 A1
(43) Pub. Date: Oct. 27, 2005

(54) System and method for applying, processing, and underwriting student loans

(76) Inventor: Donald Fenstermaker, Glendale, AZ (US)

Correspondence Address: Scott D. Watkins;Steptoe & Johnson, 1330 Connecticut Avenue, NW, Box PTO, Washington, DC, 20036, US

(21) Appl. No.: 10/832,458

(22) Filed: Apr. 27, 2004

(51) Int. Cl. G06F 17/60

(52) U.S. Cl. 705/38

(57) ABSTRACT

A loan application and processing system for student loans is supported on a server system connect to an Internet. The system includes an academic institution server facility, a financial institution communication server facility, and a Department of Education server facility, along with an interconnected database, email server, and processor, which in combination provide an integrated facility for the application and processing of student loan applications.

### BACKGROUND

1. Field of the Invention

The present invention relates to the field of electronic commerce systems, and more particularly to electronic commerce systems directed toward the application, processing, and underwriting of financial loans and student loans in particular.

2. Discussion of Background Information

Post-secondary education has great value and importance in our modern economy. Individuals with post-secondary education, particularly in the areas of math, science, and technology, are in a stronger position to compete for the best jobs. The Bureau of Labor Statistics projects that by 2010, 70 percent of the fastest growing jobs are in areas that require some type of post-secondary education, such as computer related fields and health care. In terms of economics, post-secondary education makes good business sense. Those individuals with a bachelor's degree or higher earn nearly twice as much as those who only earned a high school diploma. Consequently, there is high demand for post-secondary education. However, post-secondary education comes with a financial cost.

The U.S. Government is dedicating significant resources through the Department of Education (DOE) to improve access and reduce the financial barriers to post-secondary education for individuals by providing loan guarantees to private institutions that provide the financial loans to students or their parents. These loan guarantees fall under the Federal Family Education Loan Program (FFELP). Institutions that are eligible for originating student loans include commercial banks and credit unions, insurance companies, and non-profit student loan businesses. The DOE has projected that 10 million student loans totaling over $40 billion will issue under the FFELP and other federal student aid programs for fiscal 2003.

FFELP loans issued by private institutions are initially guaranteed by a state agency. These loans are then reinsured by the DOE against default for 95% to 100% of the principal and interest owed on the loan. Only those loans originated by private institutions that meet DOE guidelines are guaranteed by the DOE. The four primary types of FFELP loans include subsidized and unsubsidized Stafford loans, Parental Loans for Undergraduate Students (PLUS), and consolidation loans.

The acquisition of student loans is a multi-tiered process that requires students or parents to interface with commercial lenders and student financial aid offices at colleges and universities. Student loan applications are then sent by the commercial lenders to the DOE for guarantee after they are inspected to ensure that they comport with DOE guidelines. This multi-tiered process retards the ability of commercial lenders to provide prompt and immediate student loan services as is commonly demanded by customers.

### SUMMARY OF THE INVENTION

It is accordingly an object of the invention to optimize the speed and efficiency of the student loan process. A preferred embodiment of the present invention provides an integrated system that streamlines the application and processing of student loans.

According to a preferred embodiment of the present invention, a user submits a loan application over the Internet. This application includes personal information which a third party can authenticate. This personal information may also act as a “signature” for the loan application. The loan application then passes electronically to a university, which can authenticate the user from university records, add information to the loan application, and/or extract applicant information from the application. The completed application is then forwarded electronically to a regulatory body, such as the Department of Education, to determine whether the loan will be guaranteed. The regulatory body issues an appropriate notice of decision, preferably electronically.

### BRIEF DESCRIPTION OF THE DRAWINGS

The present invention is further described in the detailed description which follows, in reference to the noted plurality of drawings by way of non-limiting examples of certain embodiments of the present invention, in which like numerals represent like elements throughout the several views of the drawings, and wherein:

FIG. 1 depicts a flow chart of an overall process flow in accordance with an embodiment of the present invention;

FIG. 2A depicts a first portion of a flow chart illustrating a process for applying for a loan in accordance with an embodiment of the present invention;

FIG. 2B depicts a second portion of a flow chart illustrating a process for applying for a loan in accordance with an embodiment of the present invention;

FIG. 3 depicts a flow chart illustrating a process for authenticating a personal identity of an individual;

FIG. 4 illustrates a block diagram of a communication system in accordance with an embodiment of the present invention; and

FIG. 5 illustrates a block diagram having additional detail of a loan system in accordance with an embodiment of the present invention

### DETAILED DESCRIPTION OF THE PREFERRED EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

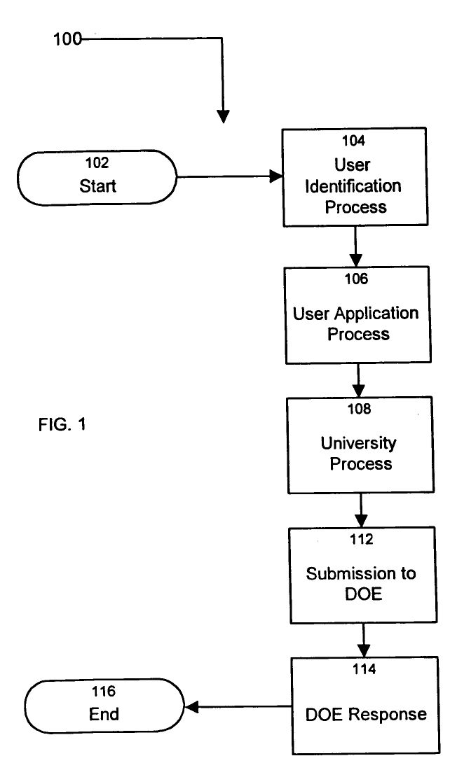

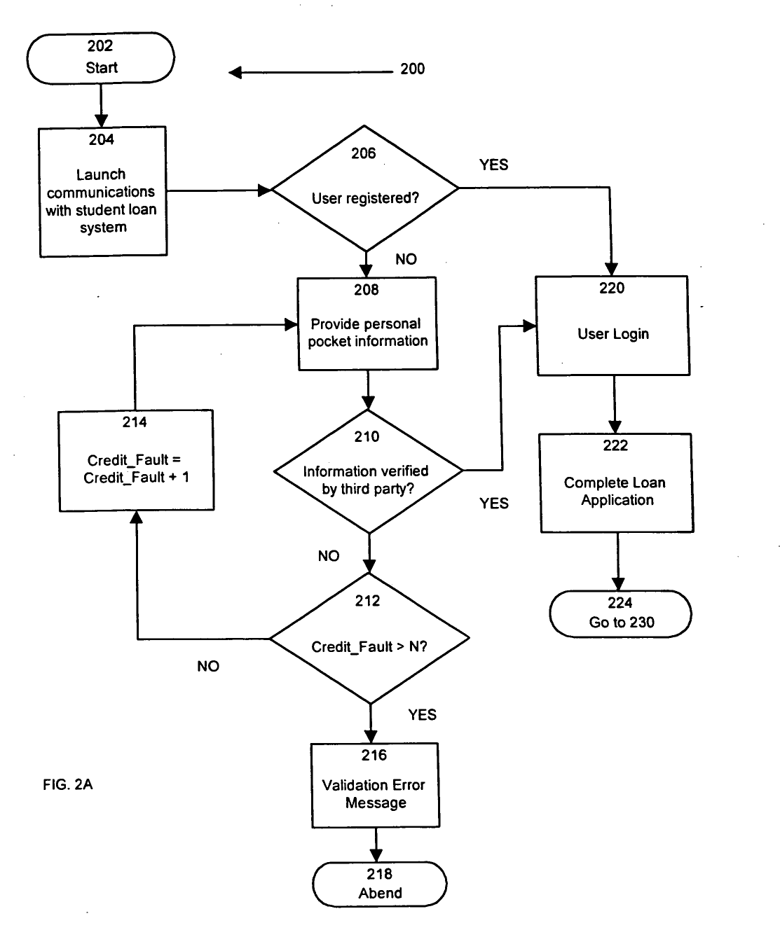

Referring to the figures by characters of reference, FIG. 1 depicts a flow chart 100 illustrating an overall process flow for the application, processing, and verification of student loans in accordance with a preferred embodiment of the present invention. The process begins at step 102 and flows to a user identification step 104.

User identification step 104 is a verification sub-process. A user preferably will go to a web page which requires the user to enter identification information, including at least personal pocket information. As used herein, “personal pocket information” refers to data of the type normally carried by a user on a card that fits in a wallet that fits within a pocket or handbag. Examples of such personal pocket information includes, but is not limited to, a driver's license number, social security number, or credit card number. The pocket information is preferably of a type that can be verified by a third party as being associated with a particular user, e.g., a financial institution that issued a particular credit card with a particular number.

The information entered by the user at step 104 is subsequently verified against a third-party database, such as a financial institution database. If this information is not verified in step 104, e.g., because the entered data does not correspond with the information in the database, student loan process 100 terminates. However, if the personal pocket information is verified, then control proceeds to user application step 106.

At step 106, a user fills out a loan application by providing information responsive to the various entries in a student loan form. This information preferably includes an identification of the universities for which the loan is being sought. The user preferably signifies acceptance of the loan application, e.g., “signs off” on the loan application, by entering the personal pocket information into the appropriate fields.

From step 106, process 100 flows to a university processing step 108, in which academic information is acquired from an academic institution database that can be used to complete and verify the student loan application processed in step 106. In step 112 the student loan application is sent to a review body to determine whether the loan will be guaranteed. By way of non-limiting example, the review body is the Department of Education, which determines whether the loan application meets appropriate regulatory guidelines for guarantee against default. In step 114, the integrated system of the present invention receives the response from the review body as to whether the student loan application meets regulatory guidelines. Then, with step 116, process 100 is completed and ended.

The process outlined by flowchart 100 allows for the application and processing of a student loan in a streamlined method. The preferred methodology as described above is to enter this information through a Graphical User Interface (GUI), such as a web browser coupled to the Internet. In the alternative, the information can be given by telephone to an operator connected to a student loan system computer 611 illustrated in FIG. 6 discussed below. Other known methods of entering information could also be used.

Process 100 provides two ways to authenticate the identity of the individual completing the student loan application. Step 104 is a sub-process where personal pocket information provided by the student loan applicant is confirmed via a communication with a financial or government institution. In a preferred embodiment, this communication involves confirming the accuracy with a financial institution of a credit card number and social security number provided by the student loan applicant. Alternatively, other pocket information such as a debit card, voter identification, or driver's license number can be used in combination with a social security number to make an initial verification of the identity of the student loan applicant through a communication with a financial institution, a department of motor vehicles, or some other government or credit institution. Based upon the outcome of this initial identify verification, student loan applicants are either allowed to continue in the process or are given an authorization failure warning.

Step 108 provides another authentication, in that the student information database of the academic institution is accessed to verify whether or not the student loan applicant is in fact registered at that institution. Part of the student loan application completed in step 106 preferably includes an identification of the academic institution attended by the student loan applicant. This verification generally includes determining whether the name, social security number, and student identification number provided by the student loan applicant matches the information in possession of the academic institution stored on their computer database. The outcome of this comparison determines whether the student loan applicant is allowed to continue with the loan process, or is provided with an authorization failure warning. Such a failure warning prevents the student loan applicant from proceeding with the loan process online.

Step 108 preferably also allows the academic institution to gather information on the student loan applicant from the academic institution's records that can be used to complete the student loan application. For instance, information concerning the number of credit hours the student is registered for in their schedules, as well as whether they are a full or part-time student is acquirable from accessing the academic institution's database. The academic institution may also take information from the loan application for its own use.

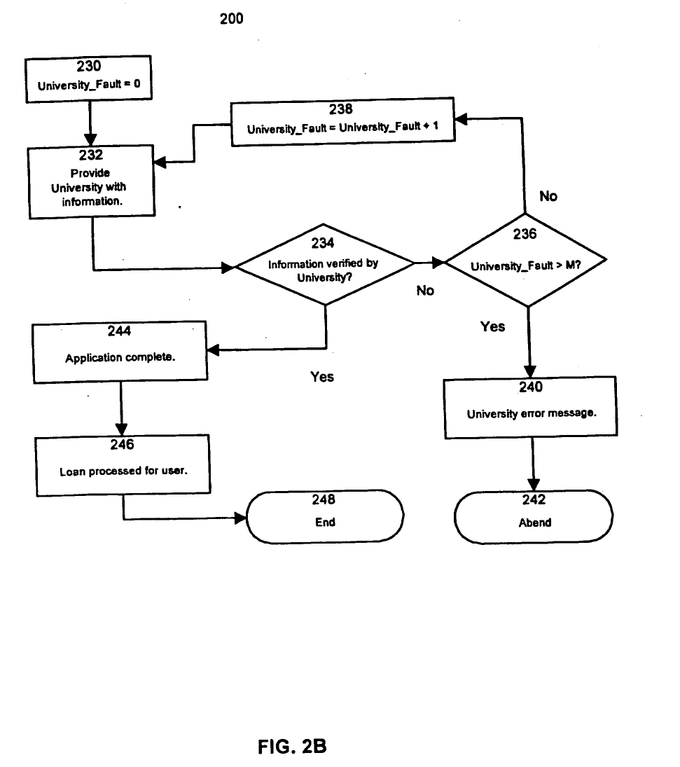

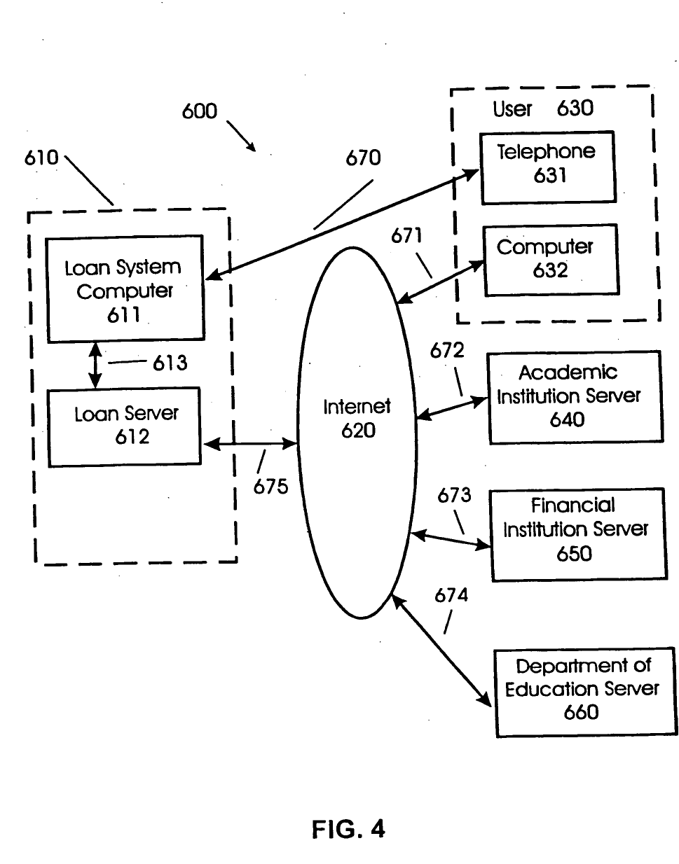

FIG. 2A depicts a flowchart 200 that illustrates a student loan application process in accordance with an embodiment of the present invention. The process begins at step 202 and flows to step 204, where the user launches a method of communication to begin the student loan application process. This method of communication, illustrated in FIG. 4, can include telephonic communication 631 with an operator utilizing a loan system computer 611. Alternatively, the user launches a WWW (Worldwide Web) browser supported on a computer 632 and accesses a server 612 through an Internet 620. In step 206, a query is made whether the user is already registered. If not, the process flows to step 208 where the user provides personal pocket information, such as credit information. From step 208, the process flows to step 210, where a query is made as to whether the personal pocket information is verified by the third party database, such as a credit bureau. In the embodiment, credit information is supplied to a credit bureau. The credit bureau provides a response message either confirming or failing to confirm the credit information provided to the credit bureau. In an alternative embodiment, a student loan applicant would submit a driver's license number in step 208. In this alternative embodiment, the system in step 210 would then submit the information to a department of motor vehicles for verification.

If the information is verified in decision step 210, the process flows to step 220. If the information is not verified in decision step 210, the process flows to decision step 212, where the check is made whether Credit_Fault exceeds the maximum number of permissible attempts N. If in decision step 212, the maximum number of permissible attempts N has not been exceeded, the process flows to step 216, where Credit_Fault is incremented by 1. Then the process flows from step 216 to step 208 for another attempt to provide credit information. However, if in decision step 212, the maximum number of permissible attempts N has been exceeded, the process flows to step 214, where a credit error message is issued to the user before the process abends (Abnormal End) in step 218.

In step 220, the user logs into the student loan system via telephone 631 or Internet 620. In step 222, the user accesses a student loan application. This access can be through either telephonic communication 670 with an operator of loan system computer 611, or through Internet 620. In step 222, the user submits application information via a message to complete the student loan application. After completing this student loan application either over phone 631 or over Internet 620, the process flows to step 224 where the process jumps to step 230 illustrated in FIG. 2B.

In step 230 of FIG. 2B, the process flows to step 232, where the student loan system provides the academic institution, which is a university in this case, with information supplied by the applicant in the student loan application. The process flows from step 232 to step 234, where the query is made whether the information is verified by the academic institution based upon a message from the university that either confirms or denies the accuracy of the information. If the information is not verified in decision step 234, the process flows to decision step 236, where the check is made whether University_Fault exceeds the maximum number of permissible attempts M. M of step 236 may be different in value from N of step 220; however, M and N may be equal. If in decision step 236, the maximum number of permissible attempts M has not been exceeded, the process flows to step 238, where University_Fault is incremented by 1. Then the process flows from step 238 to step 232 for another attempt to provide information to the university or other academic institution. However, if in step 236, the maximum number of permissible attempts M has been exceeded, the process flows to step 240, where a University error message is issued to the user before the process abends (Abnormal End) in step 242.

If in step 234, the information is indeed verified by the university or other academic institution, then the process flows from step 234 to step 244, where the application is complete. The process then flows to step 246 where the loan is processed for the user and the process ends in step 248.

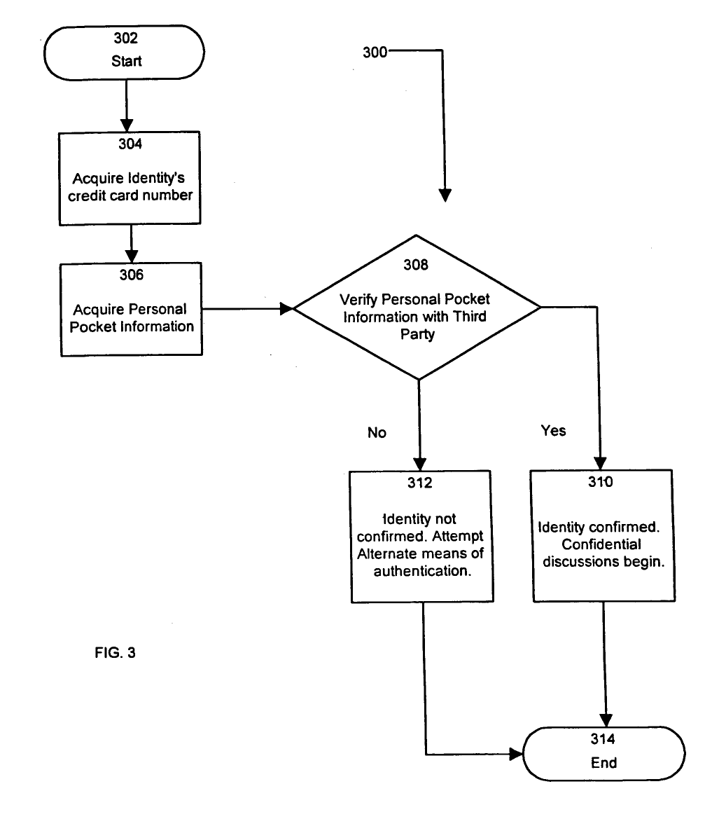

In FIG. 3, flowchart 300 depicts using the applicant's personal pocket information to obtain identity confirmation. This is where the process accesses a third party institution to verify the personal pocket information provided by the applicant. For instance, this process may contact a financial institution to verify a credit card and/or social security number. Alternatively, a State's Department of Motor Vehicles may be contacted to verify a driver's license number or voter identification.

The process begins in step 302 and flows to step 304, where the applicant's credit card information is acquired. The process flows from step 304 to step 306 where personal pocket information is acquired from the student loan applicant. This personal pocket information can include a credit card number and social security number, driver's license number, voter ID number, debit card number, or some other type of personal pocket information that an applicant may have in their purse or wallet. In a preferred embodiment, this personal pocket information is a credit card and social security number, which can be verified with a financial institution.

The process flows from step 306 to step 308, where the query is made with a third party institution as to whether the personal pocket information provided by the student loan applicant matches the information held by the third party institution. This verification process is preferably done using a social security number and credit card number, which are verified with a bank or financial institution. If such a match occurs in step 308, the process flows to step 310 where the identity is confirmed and confidential discussion begin. However, if in decision step 308, the personal pocket information does not match the information held by the third party institution, the process flows to step 312, where the identity is not confirmed. Step 312 allows alternate means of authentication, such as the maiden name of the mother of the user, the birth date of the user, the address and telephone number of the user, etc. Both steps 310 and 312 flow to end step 314.

FIG. 4 illustrates a block diagram of a communication system 600 in accordance with a preferred embodiment of the present invention. Loan system 610 includes loan system computer 611, loan server 612, and communications link 613 between computer 611 and server 612. Link 613 may be a SCSI (Small Computer System Interface) or a Fiber Channel link.

User 630 can communicate with loan system computer 611 via telephone 631. Telephone 611 communicates with loan system computer 611 via telephone link 670. Telephone link 670 may be wire or wireless. Additionally, user 630 may communicate via computer 632 to Internet 620 via link 671. Link 671 may be 56 kbs (kilo-bits per second) communications, DSL (Digital Subscriber Line), Ethernet or other Local Area Network (LAN), etc. Internet 620 links to loan server 612 via link 675, which may be 56 kbs (kilo-bits per second) communications, DSL, Ethernet or other LAN, etc. Additionally, Academic Institution Server 640, Financial Institution Server 650, and Department of Education Server 660 communicate with Internet 620 via links 672, 673, and 674 respectively. Links 672, 673, and 674 may be may be 56 kbs per second communications, DSL, Ethernet or other LAN, etc.

Communications system 600 allows for the acquisition and integration of the diverse array of information used to compile and complete a student loan application for submission to the Department of Education. Processes 100, 200 and 300 illustrated in FIGS. 1, 2, and 3 respectively preferably are supported by and implemented through communications system 600. The combination of loan system 610, internet 620, user 630, and or telephone link 670 provides for user application process 104 flow charted in FIGS. 2A and 2B.

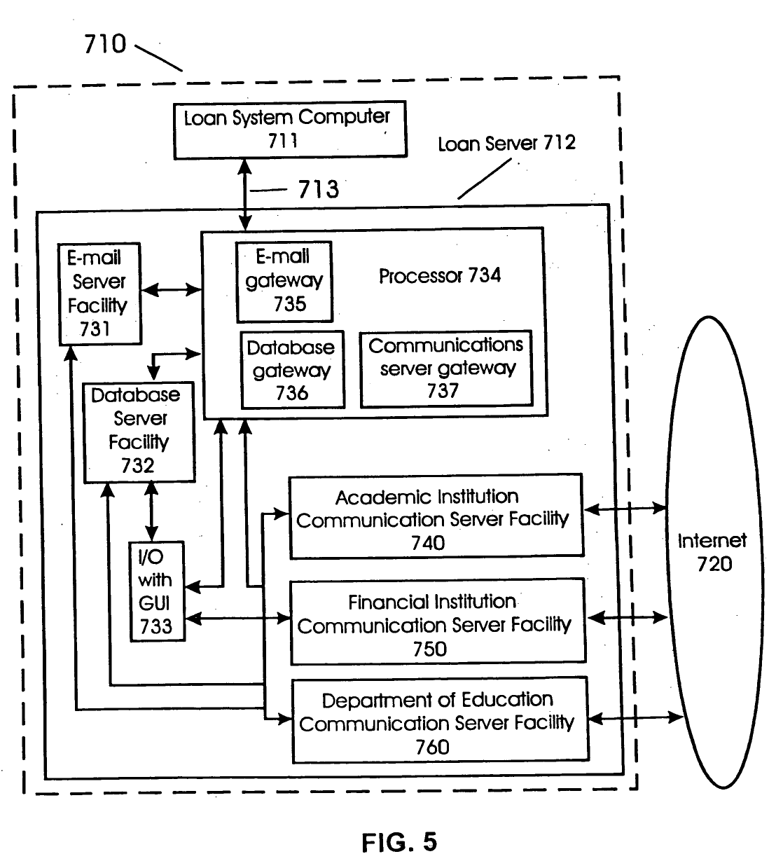

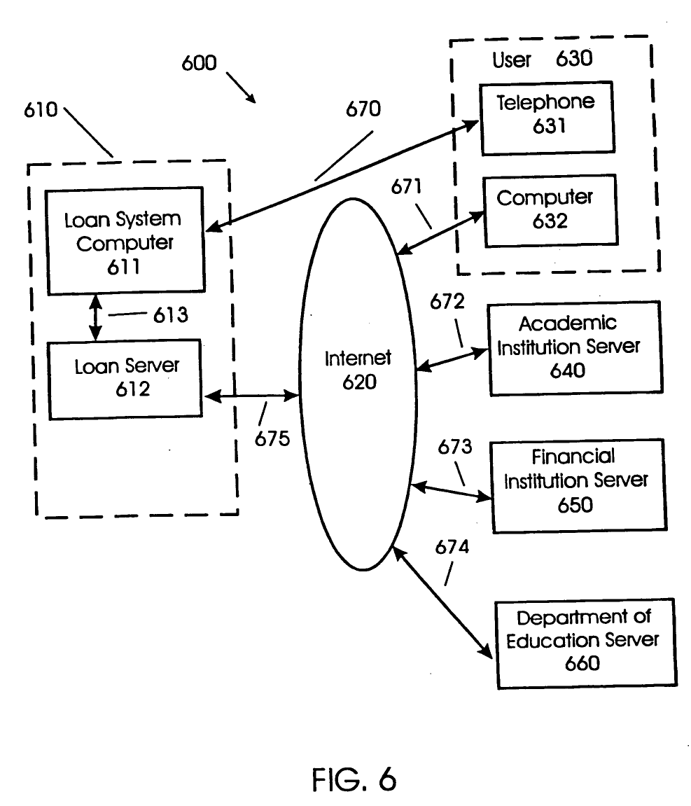

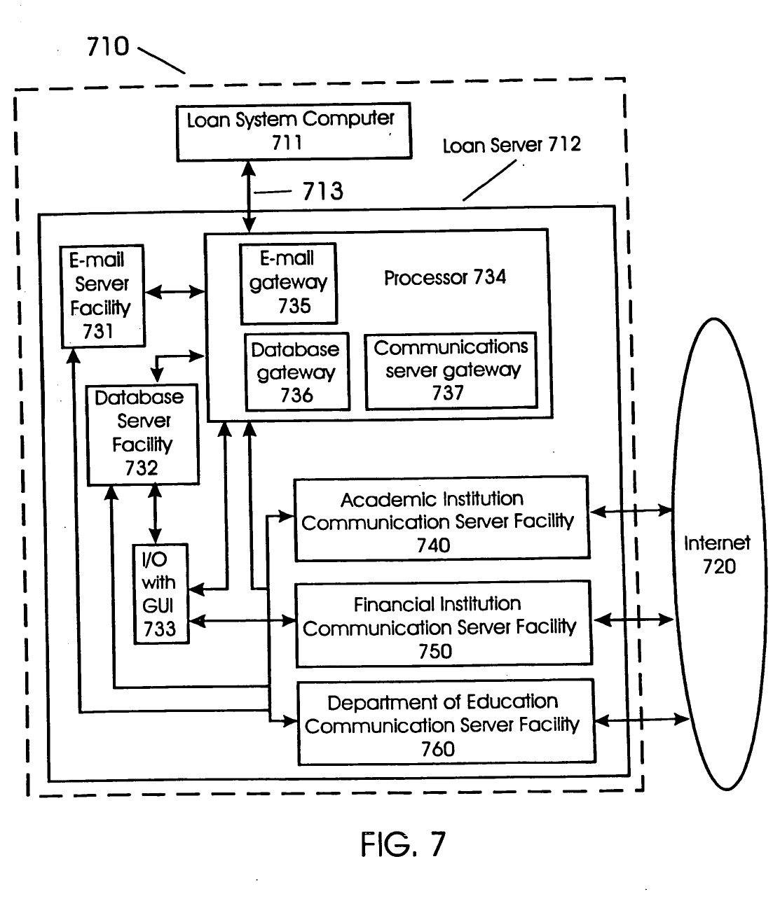

FIG. 5 illustrates a block diagram having additional detail of loan system 710 in accordance with a preferred embodiment of the present invention. Loan System Computer 711 communicates with Loan Server 712 via link 713. Link 713 may be a SCSI (Small Computer System Interface) or a Fiber Channel link. Loan Server 712 communicates to and receives communication from Internet 720 via Academic Institution Communications Server Facility 740, Financial Institution Communications Server Facility 750, and Department of Education Communications Server Facility 760. Server facilities 740, 750, and 760 communicate with Processor 734.

Processor 734 has email gateway 735, database gateway 736, and communications server gateway 737. Additionally, email server facility 731 communicates with processor 734. Email server facility also communicates with Academic Institution Communications Server Facility 740, Financial Institution Communications Server Facility 750, and Department of Education Communications Server Facility 760. Also, database server facility 732 communicates with processor 734 and Academic Institution Communications Server Facility 740, Financial Institution Communications Server Facility 750, and Department of Education Communications Server Facility 760. Finally database server facility 732 has I/O with GUI 733, as does processor 734.

Academic institution communication server facility 740 facilitates communication with Academic Institution Server 640 through Internet 620 to support the implementation of steps 230, 232, 234, 236, and 238 illustrated in FIG. 2B, where the university makes a verification of a student loan applicant's identity.

Financial institution communication server facility 750, in combination with financial institution server 650 and Internet 620 allows for the performance of credit card process 106 illustrated more thoroughly in FIG. 3. Department of Education communication server facility 760 together with Internet 620 and Department of Education server 660 allow for the submission of student loan application and communication of a response in step 112 and 114 of FIG. 1.

Email server facility 731 provides email communications regarding the student loan process and application. These emails can include automatically-generated emails such as a confirmation of a successful registration of a user and creation of a user profile in steps 206 and 208. Another email may be automatically generated at the completion of user application process 104. Further, depending upon the Department of Education response in step 114, email server facility 731 may generate an email indicating that either a student loan application has been accepted or has been declined.

Database server facility 732 stores all information gathered through GUI 733 as well as servers 740, 750, 760 and processor 734 during process 100. As needed, servers 740, 750, and 760, as well as processor 734, can access and retrieve information from database server facility 732 as process 100 may require.

GUI 733 provides the primary gateway through which user 630 can gain access to loan system 710 and initiate process 100. Alternatively, user 630 may initiate a telephonic communication 670 with an operator of a loan system computer 611. The operator of loan system computer 611 acquires the information to complete a student loan application for user 630 telephonically. The operator inputs this information into loan system computer 611 that is in communication with loan server 612 and thereby initiates and performs process 100. Loan system computer 611, together with telephone 631, serves as an alternative means of communication to Internet 620 and GUI 633 for user 630 access.

Having fully described the invention referred to in the preferred embodiments illustrated in the attached drawing figures, it will be really appreciated by those skilled in the art that many changes and modifications may be made to the invention without departing from the essence of the invention and without being included within the spirit and scope of the invention as is defined by the appended claims.

By way of non-limiting example, the personal pocket information could be submitted along with the loan application. Thus, the user could fill out the loan application, which would include the personal pocket information (which could serve at least in part as the electronic “signature” to the application). Authentication would proceed as described in the above embodiments, although the process would not have to return to the user for subsequent completion of the loan process. For the embodiment of FIG. 1, steps 104 and 106 could be combined into a single step. Similarly, for the embodiment of FIG. 2, steps 208 and 222 could be combined into a single step

1. A method for accepting and processing student loan applications, comprising the steps of:
entering data into a loan application, the data including at least personal pocket information, at least a portion of said personal pocket information representing a signature to the loan application;
providing, through at least the Internet, at least a portion of the personal pocket information to a third party server;
completing the loan application;
providing, through at least the Internet, at least a portion of information in the loan application to an academic institution;
submitting, through at least the Internet, the loan application to a review body;
receiving, from the review body and through the Internet, a decision relating to the status of the loan application.

2. The method of claim 1, wherein the at least a portion of the personal pocket information includes a credit card number.

3. The method of claim 3, wherein the third party is a financial institution.

4. The method of claim 4, wherein the third party is the financial institution that issued the credit card number.

5. The method of claim 1, further comprising generating an error message when the third party institution does not verify the at least a portion of the personal pocket information.

6. The method of claim 1, further comprising generating an error message when the academic institution does not verify the at least a portion of the personal pocket information.

7. A system for student loans, comprising:
a loan server in communication with an Internet;
an academic institution communication server facility support on said loan server, wherein said academic institution communication server facility communicates with an academic institution server through said Internet, thereby providing access to a set of student information stored on said academic institution server for use in completing a student loan application;
a financial institution communication server facility supported on said loan server, wherein said financial institution communication server facility communicates with a financial institution server through said Internet, thereby providing means to verify credit card information for use in completing said student loan application;
a review body communication server facility supported on said loan server, said Review body communication server facility communicates with a Review body server to transmit said student loan application;
an email server facility supported on said loan server to communicate information regarding said student loan application; and
a processor supported on said loan server coupling said academic institution communication server facility, said financial institution communication server facility, said Review body communication server facility, and said email server facility to said loan server.

8. The system for student loans of claim 7, further comprising a database server facility coupled to said processor, wherein a set of student loan information is stored on said database server facility.

9. The system for student loans of claim 8, further comprising a graphical user interface supported on said loan server, thereby providing user access to said loan server through said Internet.

10. The system for student loans of claim 7, further comprising a loan system computer external to said loan server coupled to said processor that can support a telephonic communication.

11. A sequence of messages for the application and processing of student loans, comprising:
an individual identity message that contains personal pocket information transmitted to a student loan system;
an identity verification message that contains said personal pocket information that is transmitted from said student loan system to a third party institution for verification;
an identity verification response message that contains an authentication statement concerning said personal pocket information transmitted from said third party institution to said student loan system;
an application message that contains student loan information used to complete a student loan application;
a university verification message that contains a set of university information sent by said student loan system to a university for authentication;
a university verification response message that contains a verification statement concerning said set of university information sent by said university to said student loan system;
a loan application message containing a completed student loan application transmitted from said student loan system to a Review body server system; and
a loan application response message containing an approval statement regarding said student loan application transmitted from said Review body server to said student loan system.

12. The sequence of messages of claim 11, further comprising a credit error message signifying that said third party institution did not verify said personal pocket information.

13. The sequence of messages of claims 11, further comprising a university error message signifying that said university did not verify said university information.

14. The sequence of messages of claim 11, wherein said individual identity message is transmitted telephonically.

15. The sequence of messages of claim 11, wherein said individual identity message is transmitted via an Internet.

16. The sequence of messages of claim 11, wherein said personal pocket information includes a credit card number and a social security number.

17. The sequence of messages of claim 11, wherein said personal pocket information includes a driver's license number.

18. The sequence of messages of claim 16, wherein said third party institution is a financial bureau.

19. The sequence of messages of claim 17, wherein said third party institution is a department of motor vehicles.
